(19) United States
(12) Patent Application Publication
(10) Pub. No.: US 2005/0168051 A1
(43) Pub. Date: Aug. 4, 2005

(54) Rotating hubcap

(75) Inventor: Ming-Fang Wang, Tainan Hsien (TW)

Correspondence Address: BACON & THOMAS, PLLC, 625 SLATERS LANE, FOURTH FLOOR, ALEXANDRIA, VA, 22314, US

(73) Assignee: Kuan Hsings Enterprise Corp., Tainan Hsien (TW)

(21) Appl. No.: 10/768,161

(22) Filed: Feb. 2, 2004

(51) Int. Cl. B60B 7/04

(52) U.S. Cl. 301/37.25

(57) ABSTRACT

A rotating hubcap comprised of a hubcap having a hole in the center, a seat, and a bearing installed in the seat. A turntable is pivotably positioned in the seated bearing, a revolving member is fastened onto the turntable, the opening in the center of the revolving member is sleeved onto the shaft member on the turntable, and the shaft members on the turntable exposed through the revolving member opening are then inserted into the bearing, such that the revolving member gyrates independently as a motor vehicle is driven.

### BACKGROUND OF THE INVENTION

1) Field of the Invention

The invention herein relates to automotive parts and accessories, specifically a rotating hubcap in which a revolving member on the hubcap generates independent gyration when a motor vehicle so equipped is moving or stationary.

2) Description of the Related Art

A conventional hubcap 1, as indicated in FIG. 1, is comprised of a round convex face 11 with a plurality of reticulations 12 in it and a plurality of clip members 13 on the posterior surface of the hubcap 1, each clip member 13 having a crook 14 at their distal extremities that provides for the circumferential support of a steel ring 15 which is fitted onto the wheel 21 rim 21 of a tire 3 having the same outer diameter.

The U.S. Pat. No. 5,490,342 (Non-rotating Wheel Cover) utilizes a counterweighted disc member mounted on the wheel cover such that the counterweighted disc member does not rotate along with the wheel and wheel cover as the host vehicle is driven. In other words, the disc member remains static to enable the reading of the indicia displayed on the disc member.

The U.S. Pat. No. 5,588,715 (Non-rotating Wheel Cover Assembly) introduces a wheel cover that is suspended and not directly supported on the tire-mounted wheel of a motor vehicle, wherein a weight is applied on the periphery of the wheel cover such that the wheel cover remains non-rotational when the vehicle is moving. As such, patterns and shapes on the surface of the wheel covers are clearly discernable as the tires rotate.

To allow inertial separation and thereby achieve the objective of designing a wheel cover or a disc member that is non-rotating, the said two inventions utilize either bearings or a disc member on the wheel cover followed by the placement of a weight on the wheel cover or disc member. However, hubcap differences arise from differences in definition. For example, the hubcap 1 shown in FIG. 1 is fully mounted on the wheel and incapable of free rotation and, furthermore, viewing indicia on it during wheel rotation is not significant because that was not a requirement. Thus, the identical use of bearings to facilitate rotation may culminate in contrasting results and applications. In the case of the said U.S. Pat. Nos. 5,490,342 and 5,588,715, both inventions include bearings for gyrational purposes and even the distribution of weights to keep the wheel cover or disc member stationary during wheel rotation, but the results and applications are not the same.

### SUMMARY OF THE INVENTION

The objective of the invention herein is to provide a rotating hubcap comprised of a hubcap having a round convex face, a plurality of reticulations arrayed in the said round convex face, and a plurality of clip members on the posterior surface of the said hubcap in which a hole and a seat are disposed at the center of the said hubcap and, furthermore, a bearing is mounted in the said seat; a turntable is pivotably positioned in the said bearing held by the said seat, a revolving member is fastened onto the said turntable, the opening in the center of the revolving member is sleeved onto the shaft member on the turntable, and the shaft members on the turntable exposed through the revolving member opening are then inserted into the said bearing, such that the said revolving member gyrates independently as a motor vehicle is driven.

### BRIEF DESCRIPTION OF THE DRAWINGS

Other features and advantages of the present invention will become apparent in the following detailed description of the preferred embodiments, with reference to the accompanying drawings, in which:

FIG. 1 is a cross-sectional drawing of a conventional wheel with a mounted tire.

FIG. 2 is an exploded drawing of the preferred embodiment of the invention herein.

FIG. 3 is an exploded drawing of a section of the preferred embodiment of the invention herein.

FIG. 4 is a cross-sectional drawing the preferred embodiment of the invention herein.

FIG. 5 is an isometric drawing of the preferred embodiment of the invention herein.

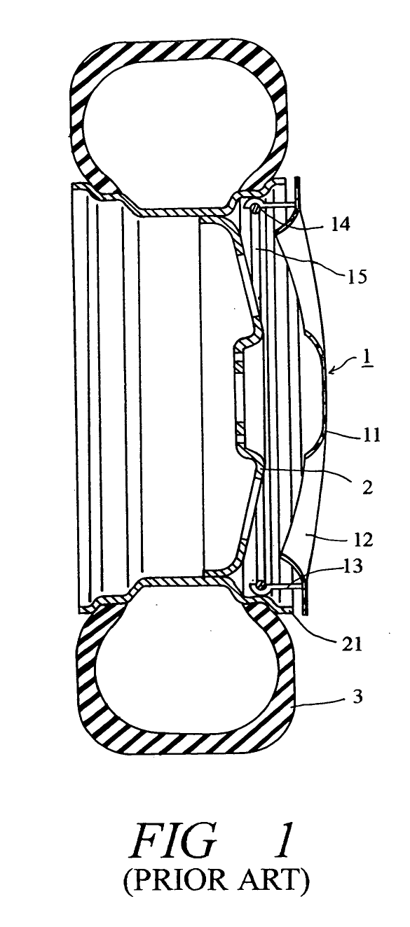

### DETAILED DESCRIPTION OF THE PREFERRED EMBODIMENTS

In the detailed description of the preferred embodiment, it should be noted that identical elements are indicated by the same reference numerals throughout the disclosure.

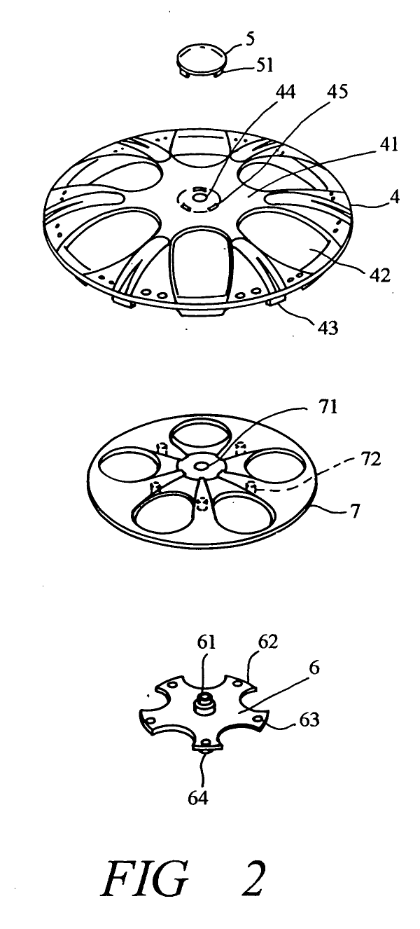

Referring to FIG. 2, the preferred embodiment of the invention herein is comprised of:

A hubcap 4 consisting of a round convex face 41 with a plurality of reticulations 42 and a plurality of clip members 43 on the posterior surface of the hubcap 4 that provides for the circumferential support of a steel ring (not shown in the drawings) which is fitted onto a wheel of the same outer diameter; a hole 44 is formed at the center of the hubcap 4 and a plurality of insert slots 45 are formed at equal intervals apart around the hole 44.

A hood cover 5 having a plurality of catches 51 aligned with the insert slots 45 around the hole 44 that is insertionally fitted over the hole 44.

A turntable 6 having disposed on it a shaft member 61 and a plurality of rest mounts 62; each rest mount 62 has a locating hole 63 and a shallow sleeve 64 is formed under each locating hole 63.

A revolving member 7 that is a thin circular platter having an opening 71 through the center and a plurality of mounting posts 72 projecting at equal intervals apart adjacent to the periphery of the opening 71.

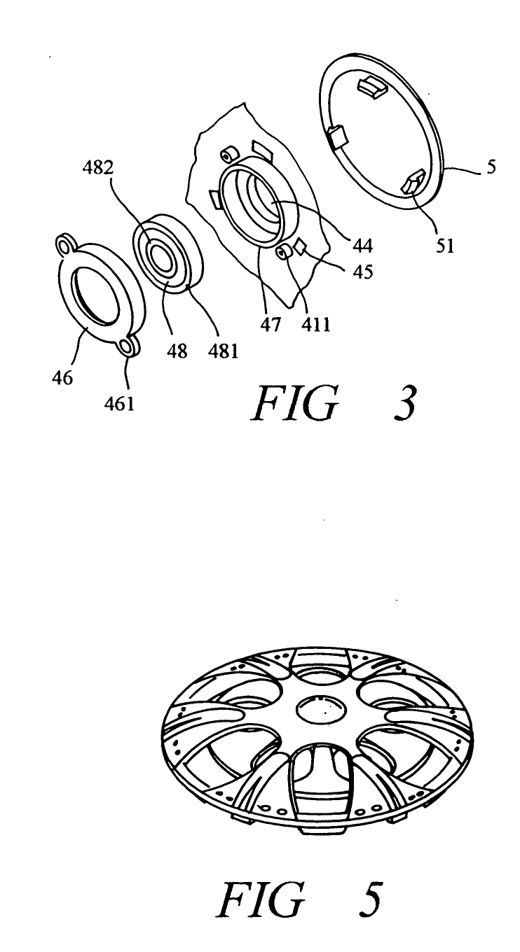

Referring to FIG. 3 and FIG. 4, a seat 47 is formed on the posterior surface of the hubcap 4 and a bearing 48 is pressed into the seat 47; the bearing 48 has an outer ring 481 and an inner ring 482, of which the outer ring 481 is positioned within the seat 47; a shell mount 46 having radially symmetrical mounting tabs 461 covers the bearing 48 and the seat 47, and is affixed to mounting columns 411 outside the seat 47 by means of fastening components 462 situated through the mounting tabs 461.

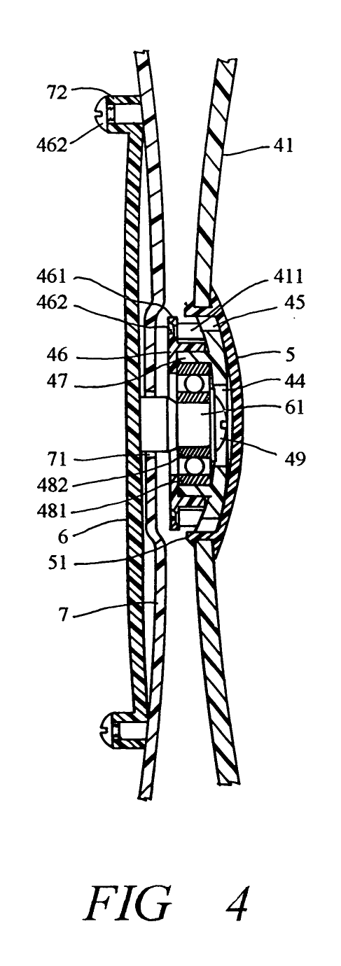

Referring to FIG. 3 and FIG. 4, in terms of assembly, the bearing 47 is first installed into the seat 47, the shell mount 46 is placed over the bearing 47 and fastened outside the seat 47; the opening 71 in the center of the revolving member 7 is sleeved onto the shaft member 61 on the turntable 6, enabling the respective insertion of the mounting posts 72 on the revolving member 7 into the locating holes 63 in the turntable 6 and the conjoinment of the revolving member 7 and the turntable 6 into a unitary entity by means of the fastening components 65, the shaft members 61 on the turntable 6 exposed through the revolving member 7 opening 71 are then inserted into the inner ring 482 of the said bearing 48, a fastening component 49 having a head section larger than the interior diameter of the bearing 48 inner ring 482 is admitted from the hubcap 4 opening 46 and screwed onto the extremity of the shaft member 61 against the inner ring 482 end portion such that the turntable 6 is fixed to the bearing 48 but still capable of free gyration, following which the catches 51 on the hood cover 5 are aligned with and inserted into the insert slots 45 in the hubcap 4 to cover and conceal the hole 44, thereby completing the rotating hubcap shown in FIG. 5.

When the host vehicle is driven and the tires are rotating, since the hubcaps 4 are installed on conventional wheels, they rotate along with them; as the hubcaps 4 are in clockwise rotation, the effect of the air flow on the revolving member 7 causes the revolving members 7 to rotate counter-clockwise relative to the hubcaps 4; when the vehicle stops, the revolving members 7 are spun by ambient air currents or wind.

How many said mounting posts 72 are utilized is based on the number of reticulations 42 in the round convex face 41 of the hubcap 4 as well as their shape; a conventional hubcap 4 typically has three, four, five, or eight reticulations 42, the rotating members 7 in the preferred embodiment of the invention herein are disc-shaped members but can be a quantity of differently shaped members disposed at equal intervals apart.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A rotating hubcap comprised of:
A hubcap having a round convex face, a plurality of reticulations arrayed in the said round convex face, and a plurality of clip members on the posterior surface of the said hubcap; a hole and a seat are disposed at the center of the said hubcap and, furthermore, a bearing is mounted in the said seat.
The features of which are that a turntable is pivotably positioned in the said bearing held by the said seat, a revolving member is fastened onto the said turntable, an opening in the center of a revolving member is sleeved onto a shaft member on the said turntable, and the said shaft members on the said turntable exposed through the said revolving member opening are then inserted into the said bearing, such that the said revolving member gyrates independently as a motor vehicle is driven.

2. As mentioned in claim 1 of the rotating hubcap invention herein, the said bearing has an outer ring and an inner ring, of which the said outer ring is positioned within the said seat, the said turntable has the said shaft member disposed on it that is inserted into the said inner ring of the said bearing, and a fastening component having a head section larger than the interior diameter of the said bearing inner ring is screwed onto the extremity of the said shaft member against the said inner ring end portion such that the said turntable is fixed to the said bearing.

3. As mentioned in claim 1 of the rotating hubcap invention herein, the said revolving member has a plurality of mounting posts projecting at equal intervals apart adjacent to the periphery of its said opening.

4. As mentioned in claim 3 of the rotating hubcap invention herein, the said turntable has a plurality of rest mounts on it and a locating hole is disposed in each rest mount; the said mounting posts on the said revolving member are respectively inserted into the said locating holes in the said turntable and the said revolving member and the said turntable are conjoined into a unitary entity by means of fastening components.

5. As mentioned in claim 3 of the rotating hubcap invention herein, the said bearing and said seat are covered by a shell mount having radially symmetrical mounting tabs that are affixed to mounting columns outside the said seat by means of fastening components situated through the said mounting tabs.
